(19) United States
(12) Patent Application Publication
(10) Pub. No.: US 2025/0392345 A1
(43) Pub. Date: Dec. 25, 2025

(54) METHODS AND APPARATUS FOR CONTROL AND MANAGEMENT SYSTEM USING DIRECT SEQUENCE SPREAD SPECTRUM RADIO

(71) Applicant: Pro Alarm Service LLC, Glendale, AZ (US)

(72) Inventors: John Schwartz, Glendale, AZ (US); R Craig Boswell, Blaine, WA (US); Joseph Butler, Gilbert, AZ (US)

(73) Assignee: Pro Alarm Service LLC, Glendale, AZ (US)

(21) Appl. No.: 19/234,613

(22) Filed: Jun. 11, 2025

Related U.S. Application Data
(60) Provisional application No. 63/661,688, filed on Jun. 19, 2024.

(51) Int. Cl. H04B 1/707; H04L 5/00; H04L 27/26; H04W 72/30

(52) U.S. Cl. CPC H04B 1/707; H04L 5/003; H04L 27/2692; H04W 72/30

(57) ABSTRACT

A control and management system using direct sequence spread spectrum radio within the 900 MHz frequency band may be configured act as a one-to-many bridge between a central access control system or server and a plurality of peripherally connected remote devices communicatively linked to the server through a wireless hub. The wireless hub acts as a wireless bridge between the central access control system and the plurality of peripherally connected remote devices to create an access control and building management system. The wireless hub and peripherally connected devices are configured to scan channels within the 900 MHz band to detect and reply to a transmitted data packet on a randomly selected channel. The disclosed technology allows the data rate to be dynamically adjusted to optimize the time on air. By dynamically adjusting time on air, a wireless repeater may be used to decrease any latency between the peripherally connected remote devices to approximately the same as higher data rate systems, while providing substantial increases to the range between the peripherally connected remote devices and the wireless hub.

### CROSS REFERENCES TO RELATED APPLICATIONS

This application claims the benefit of U.S. Provisional Patent Application No. 63/661,688, filed Jun. 19, 2024, and incorporates the disclosure of the application by reference.

### BACKGROUND OF THE TECHNOLOGY

Access control for secure entry locations and building management systems currently utilize a combination of methods to control access points and devices like direct wired connections and wireless technologies such as Z-wave, Bluetooth low energy, and wi-fi communication protocols alone or in some combination to manage communications between access points and a controller/server. These communication protocols are applicable for short-range, high bandwidth applications, but do not perform well in long range applications due to a tradeoff between data rate and distance. Modern systems typically opt for higher data rate to reduce latency between a request and a response. While providing quicker response times (lower latency), this choice may result in higher installation costs due to having to include additional communication hubs across multiple locations to provide enough coverage for a given installation area. Alternatively, these systems may have to rely on the users' peripheral devices (such as a smartphone) to keep the system up to date and may result in additional complications or compatibility issues.

Some systems that have opted for operational distance over a high data rate, utilize a point-to-point, low data rate system using long range (LoRa) protocol. This type of installation may not be practical in situations involving higher number of users due to latency issues that may decrease response time. While these point-to-point systems can be daisy chained together to repeat the access control data farther, the latency experienced by the user is doubled since the time on air is doubled further decreasing response times.

### SUMMARY OF THE TECHNOLOGY

A control and management system using direct sequence spread spectrum radio within the 900 MHz frequency band may be configured act as a one-to-many bridge between a central access control system or server and a plurality of peripherally connected remote devices communicatively linked to the server through a wireless hub. The wireless hub acts as a wireless bridge between the central access control system and the plurality of peripherally connected remote devices to create an access control and building management system. The wireless hub and peripherally connected devices are configured to scan channels within the 900 MHz band to detect and reply to a transmitted data packet on a randomly selected channel. The disclosed technology allows the data rate to be dynamically adjusted to optimize the time on air. By dynamically adjusting time on air, a wireless repeater may be used to decrease any latency between the peripherally connected remote devices to approximately the same as higher data rate systems, while providing substantial increases to the range between the peripherally connected remote devices and the wireless hub.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a spread spectrum radio control and management system in accordance with an exemplary embodiment of the present technology;

FIG. 2 representatively illustrates a spread spectrum radio control and management system with integrated nodes in accordance with an exemplary embodiment of the present technology;

FIG. 3 representatively illustrates an embodiment where each node is connected to multiple remote devices in accordance with an exemplary embodiment of the present technology;

FIG. 4 representatively illustrates a frequency hopping process in accordance with an exemplary embodiment of the present technology;

FIG. 5 representatively illustrates an alternative embodiment of a spread spectrum radio control and management system in accordance with an exemplary embodiment of the present technology;

FIG. 6 representatively illustrates an alternative embodiment of a spread spectrum radio control and management system with independent receivers in accordance with an exemplary embodiment of the present technology;

FIG. 7 representatively illustrates an alternative embodiment of a spread spectrum radio control and management system incorporating a wireless repeater in accordance with an exemplary embodiment of the present technology;

FIG. 8 representatively illustrates a method of confirming data transmission in accordance with an exemplary embodiment of the present technology;

FIG. 9 representatively illustrates another alternative embodiment of a spread spectrum radio control and management system in accordance with an exemplary embodiment of the present technology;

FIG. 10 representatively illustrates an alternative embodiment of a spread spectrum radio control and management system incorporating an adapter board in accordance with an exemplary embodiment of the present technology;

FIG. 11 representatively illustrates a first method of transferring data using an OSDP process in accordance with an exemplary embodiment of the present technology;

FIG. 12 representatively illustrates a second method of transferring data using an OSDP process in accordance with an exemplary embodiment of the present technology; and

FIG. 13 representatively illustrates an alternative embodiment of a spread spectrum radio control and management system incorporating a gateway in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of materials, electronics, transmitters, receivers, radios, and communication devices. In addition, the present technology may be practiced in conjunction with any number of radio equipment, and the system described is merely one exemplary application for the technology. Methods and apparatus for a control and management system using direct sequence spread spectrum radio according to various aspects of the present technology may operate in conjunction with any suitable radio communication equipment such as a wireless transmitters, receivers, wireless hubs, nodes, adapters, servers, and other wireless or wired communication equipment. For example, the disclosed technology may be used to provide a user with control or ability to manage multiple smart devices, sensors, and entry points of a location to provide the ability to control or monitor access through each entry point.

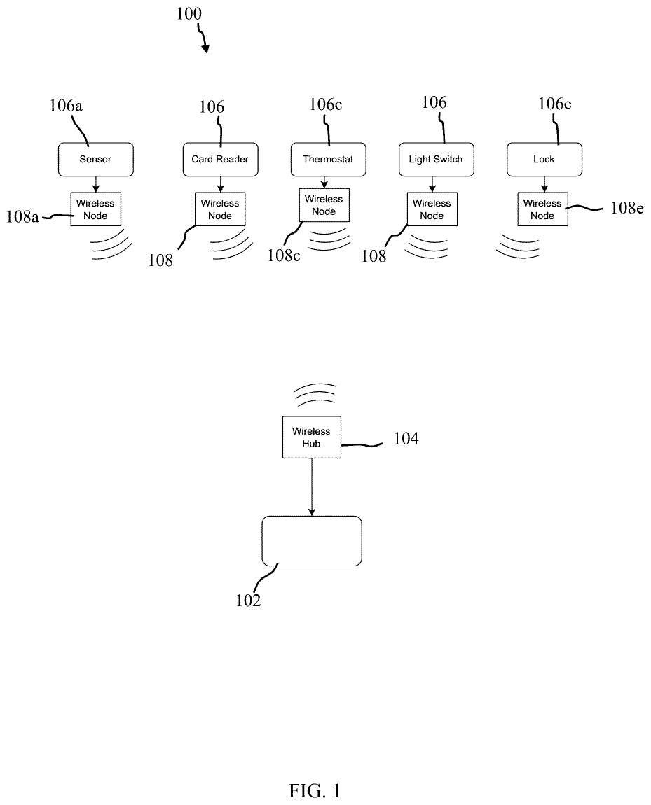

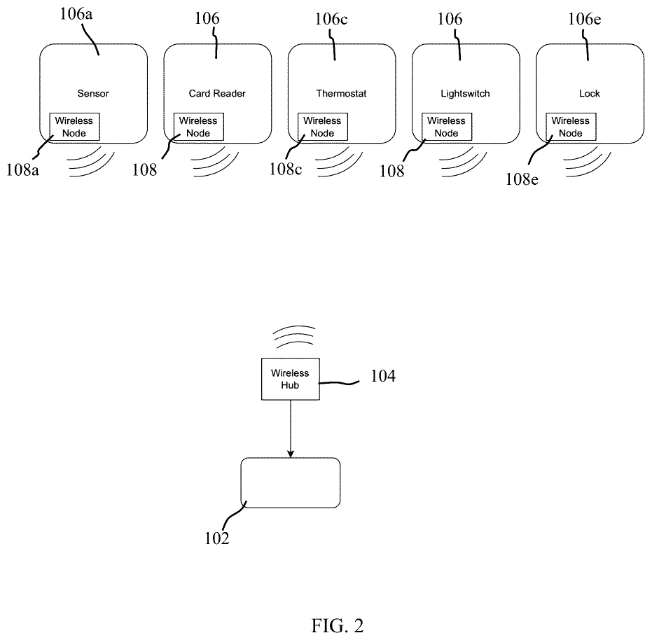

Referring now to FIGS. 1 and 2, in a representative embodiment, a control and management system 100 using direct sequence spread spectrum radio may be configured act as a one-to-many bridge between a central access control system or server 102 and a plurality of peripherally connected remote devices 106a-106e. The central access control system 102 may comprise any system or device configured to act as a centralized control system and may be a dedicated access control system or a centralized server adapted to distribute commands or queries in the form of a data packet to the peripherally connected remote devices 106a-106e. The data packet may contain any suitable information or data to control or otherwise communicate with the plurality of peripherally connected remote devices 106a-106e. For example, a first data packet may contain instructions for an entry door to unlock to allow access through the door or for a light switch to turn on or off. A second data packet may contain instructions for one or more remote devices 106a-106e to update a locally stored set of data. A third data packet may contain instructions for a specific thermostat to change its settings. Other data packets may be similarly generated and sent to control any number of or type of smart devices connected to the system as a peripherally connected remote device 106.

The plurality of peripherally connected remote devices 106a-106e may be distributed over a large area or located at a distance from the central access control system 102 that wouldn't typically lend itself to a Z-wave, Bluetooth low energy, or wi-fi based system. In a first representative application, such as building management where individual remote devices 106 are located throughout a building are controllable, the system 100 may be configured to relay data (e.g., commands, status information, etc.) to any number of installed remote devices 106 such as: thermostats, light switches, ceiling fans, electrical outlets, locks, sensors, cameras, motors, and the like. Groups of peripherally connected remote devices 106 may be collocated in defined areas such as a residential unit, office suite, lobby, etc. In a second representative application such as a secure access control system, the system 100 may be configured to relay data to various types of access control devices such as: card readers, relays, and sensors.

In this embodiment, a central access control system 102 may be coupled to a wireless hub 104. The wireless hub 104 is configured to communicate with a plurality of nodes 108a-108e, wherein each node 108 is coupled to an individual remote device 106. As shown in FIG. 2, a node 108 may be embedded within a peripheral remote device 106 rather than installed as a standalone device. The nodes 108a-108e and wireless hub 104 communicate and bridge the data between the central access control system 102 and the individual remote devices 106a-106e. The central access control system 102 and peripherally connected remote devices 106a-106e function the same as if they were wired physically. By contrast, in current short range systems the central access control system 102 is coupled directly to the remote devices 106 and the hub 104 and may experience slightly lower latency in communication.

The wireless hub 104 may also be configured to be connected to a cloud server (not shown) to allow for remote management of the system 100. A remote connection would allow a user (e.g., a building manager) to monitor the activity of the system, change settings, and remotely disable functions. The wireless hub 104 may also act as a one-to-one bridge device to provide control over a single peripheral device 106.

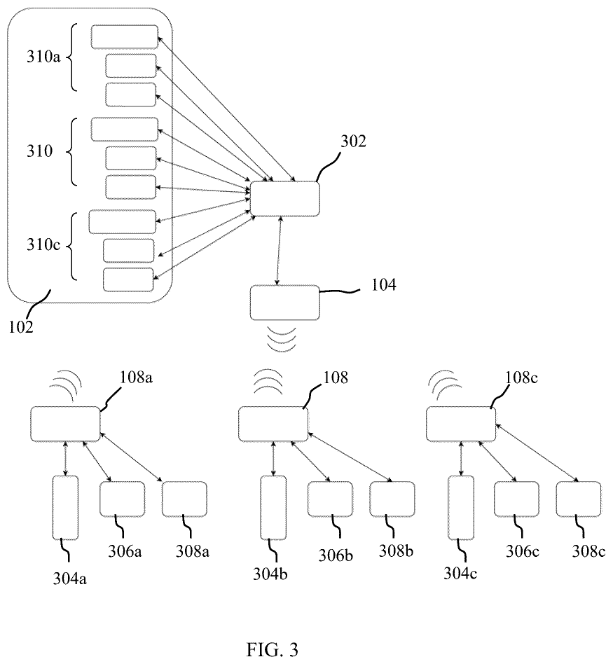

Referring now to FIG. 3, in another embodiment, each node 108a-c may be configured to provide control over multiple remote devices. Instead of wiring each remote device to the central access control system 102 as is common in current access control systems, this embodiment allows for wireless control of devices that would traditionally be part of a wired access control system. For example, a first node 108a may be communicatively linked to a plurality of remote devices such as a first card reader 304a, a first door strike 306a, and a first door sensor 308a. The remote devices 304a, 306a, 308a may be connected to or configured to communicate with the first node 108a by any suitable method such as hard wired or through another wireless communication protocol. Similarly, a second node 108b may be communicatively linked to a second plurality of remote devices such as a second card reader 304b, a second door strike 306b, and a second door sensor 308b.

The hub 104 may be connected to the central access control system 102 in a similar manner as described above with the exception that an adapter board 302 may be positioned between the hub 104 and the central access control system 102. Individual groups of sensors 310a, 310b, and 310c connected to the central access control system 102 may be configured to send or receive signals to the adapter board 302. The adapter board 302 may then communicate with the nodes 108a-c via the hub 104.

The adapter board 302 and the hub 104 may be configured to communicate or transfer data signals by any suitable method. For example, in one embodiment, a RS-485 bus may be used to transmit communication signals between the adapter board 302 and the hub 104. The wired nature of this connection may allow for the hub 104 to be positioned at a distance from the central access control system 102 and increase the overall range of the system.

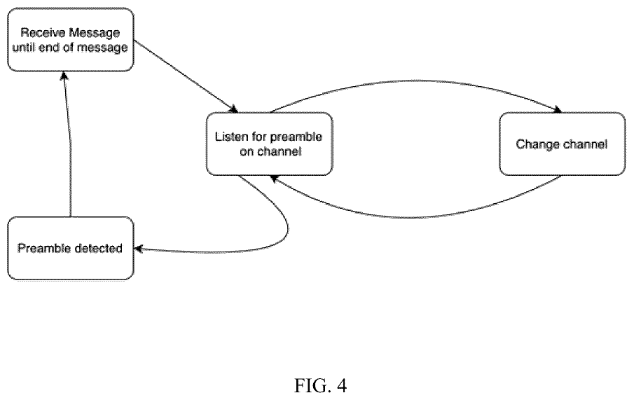

Referring now to FIG. 4, the hub 104 may be configured to transmit a data packets at 1W within the 900 MHz frequency band to increase the range of the system. Due to the crowded nature of this radio frequency, there is an increased probability of interference on any given channel. Therefore, to reduce the chances of interference or noise, the hub 104 and the nodes 108 may be configured to continuously hop across multiple frequencies (channels) within the 900 MHz band. For example, in one embodiment, the system 100 may be configured to frequency hop across at least 50 different channels within the 900 Mhz band. A problem that may occur as a result of frequency hopping is that one or more remote devices 106 may get out of sync with the hub 104 as information is communicated. Out of sync devices can cause problems if the hub 104 is intending to transmit a data packet to a specific remote device 106 on a given channel but the targeted remote device isn't on that channel.

One method to achieve and keep the remote devices 106 in sync is to continuously search all hop frequencies for a preamble. The preamble may comprise a specific sequence of data programmed to be transmitted immediately before the intended data packet. The preamble length and time on air may be set so that the targeted remote device 106 is able to search through all frequencies in less time than it takes to transmit the preamble. By limiting the length of the preamble, each remote device 106 is ensured of being able to detect the preamble regardless of which frequency it is on when the hub 104 begins to transmit a data packet. Once the remote devices 106 detect the preamble it temporarily stops frequency hopping and receives the incoming data packet on the channel it detected the preamble.

If the time spent on each channel while frequency hopping is minimized, the time to search all 50 channels can be used for an access control system because the response time is within a tolerable delay for a door to open (approximately a second). The system 100 may also be capable of decreasing the latency by increasing the data rate, with distance being affected negatively as the rate increases. Frequency modulation may be used to increase or decrease range while maintaining a desired latency.

The combination of operating in the 900 MHz band and frequency hopping allows the system 100 to have a high number of peripherally connected remote devices 106 communicating with the central access control system 102 and maintain a much larger operational range than other systems. A potentially limiting factor of the number of peripherally connected remote devices 106 the system can handle is the occurrence of simultaneous transmissions of data between remote devices 106 and the central access control system 102. A potential solution to missed transmissions of data packets is for a transmitting device to wait for a period of time after transmitting a data packets corresponding to when it should have received an acknowledge back from the intended receiving device.

All connected remote devices 106 or nodes 108 may be configured to send the preamble and be responsive to the detection of the preamble. In one embodiment, the preamble may be programmed into the radio of each device so that it may be able to detect if the data packet it is receiving at that time is data from the system 100 or if it is from something else such as a 3rd party system operating on the same channel or interference. The preamble may be fixed and programmed across all connected devices to create a unified system.

In operation, all connected devices on the system 100 may be responsive to the preamble. This may help keep the remote devices 106 in sync with the hub 104. For example, upon detection of the preamble, each remote device 106 may temporarily stop scanning the available channels and instead remain on the channel in which the preamble was detected to then receive the transmitted data packet.

Because each remote device 106 or node 108 is configured to receive the data packet upon detection of the preamble, the result is that at least one remote device 106 or node 108 will receive a data packet that was intended for another remote device 106 or node 108. Because there is little value in receiving a data packet intended for another remote device 106 or node 108, each connected device may be configured to disregard certain data packets. For example, a data payload making up the data packet, may comprise a device ID unique to the particular remote device 106 or node 108 that the remaining data packet is intended for. Once a preamble is detected, each remote device 106 or node 108 may compare the device ID in the data payload to its own device ID to determine if data is meant for it.

If the device IDs do not match, then the remote device 106 or node 108 may disregard the rest of the data packet and resume the frequency hopping process. If the device IDs do match, then the remote device 106 or node 108 may receive the data packet and send an acknowledgement confirming the data packet was received. The remote device 106 or node 108 may then analyze or otherwise process the data packet and perform a specified function or reply with an appropriate response.

Another mechanism for the remote device 106 or node 108 to filter out messages not intended for them is by encrypting the data. If the receiving remote device 106 or node 108 decrypts the data and it doesn't match the Device ID or a predetermined pattern then it may ignore the data.

In the event that two or more connected remote devices 106 or nodes 108 send data at the same time, the first one that gets picked up in the search by the hub 104 will be received, based on channel search sequence of the receiving device. The device that didn't successfully transmit the data to the hub 104 will wait for a set period of time for an acknowledgement from the server. If the hub 104 doesn't reply within that time, then the device knows there must have been a collision or the hub 104 was busy, and it should try again.

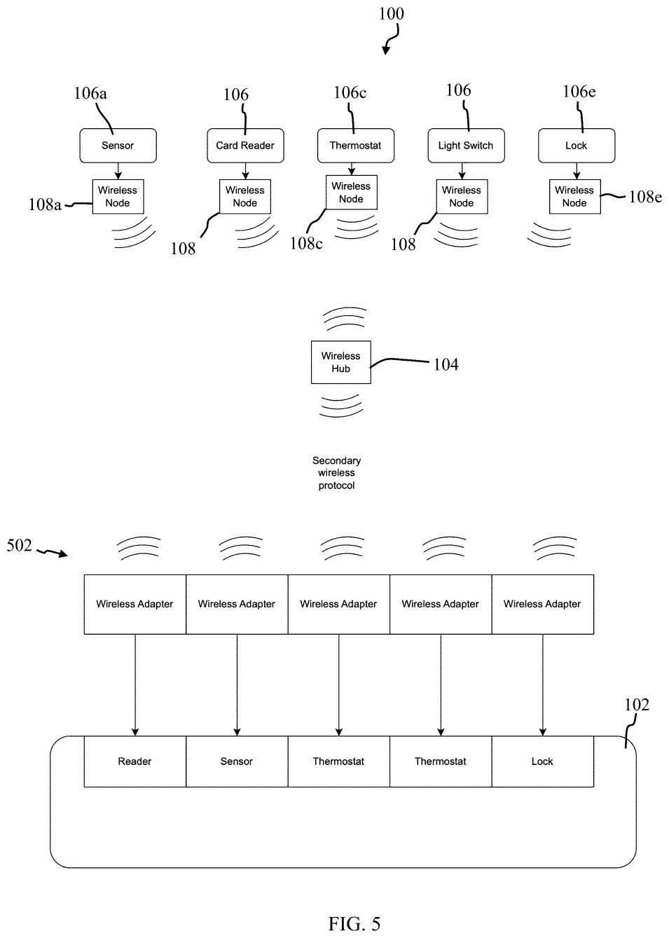

Referring now to FIG. 5, in a another representative embodiment, the control and management system using direct sequence spread spectrum radio 100 may be configured with a secondary wireless protocol between the central access control system 102 and the hub 104. In this embodiment, a plurality of adapter devices 502, specific to each protocol and wiring type, may be wired directly to the central access control system 102, and wirelessly transmit data between the hub 104 and the central access control system 102. The secondary wireless protocols can include but are not limited to Bluetooth low energy, Wi-Fi, and a proprietary 900 Mhz narrow band protocol. The secondary wireless connection between the hub 104 and the central access control system 102 is made to operate simultaneously with the primary 900 MHz RF connection between the hub 104 and the plurality of peripherally connected remote devices 106a-106e.

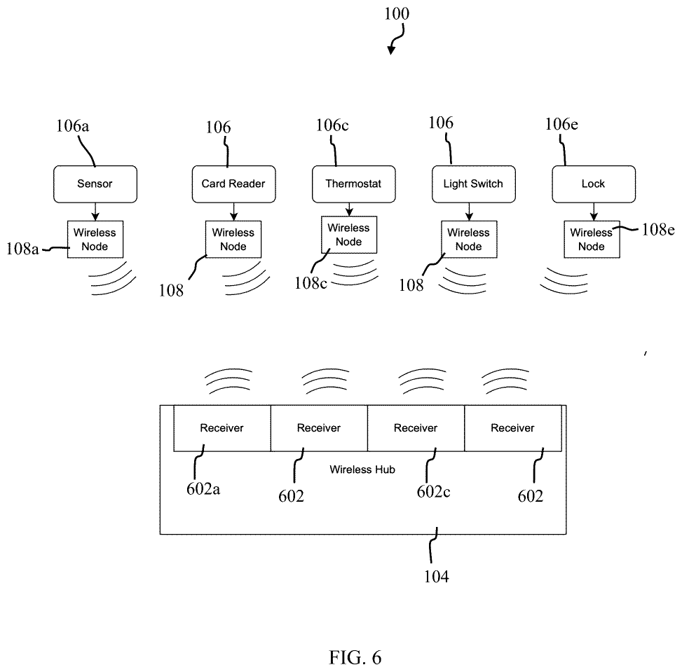

Referring now to FIG. 6, in yet another representative embodiment, the hub 104 may further comprise multiple receivers 602a-602d to provide the ability to receive data from multiple connected remote devices 106 simultaneously. Simultaneous operation may be achieved by dynamically adjusting the frequency, bandwidth, and spreading factor of the connected remote devices 106 to have the devices operate simultaneously without interference. For example, the hub 104 may be configured to increase the bandwidth of a first node device 108a that is nearer than a second node device 108b positioned farther away. When both node devices 108a, 108b communicate the two receivers 402a, 402b in the hub 104 are able to receive both simultaneously because the data is sent on two different bandwidths. Alternatively, similar results may be achieved if the hub 104 is configured to time multiplex the nodes 108 and assign them time slots for the hub 142 to receive data.

In an access control system embodiment, different on air times may not be a desirable situation because some doors may open at varying response times. For example, an access door located closer to the hub 104 may have a shorter response time (door being unlocked/opened) than a door located farther from the hub 104. To provide a more consistent on air time, or time to open a door, the central access control system 102 may be configured to determine the longest on air time connection of all the remotely connected devices 106 and then introduce a delay to all other shorter on air time devices to simulate a latency of the longest on air time connection (e.g., ½ second) before opening the door and subsequently maintaining a consistent “door opening time” for users throughout the system. This may have a practical result of eliminating or reducing the occurrence of complaints for doors that open slower than others.

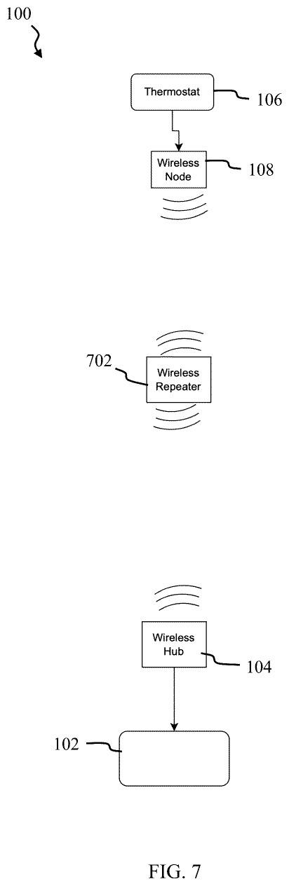

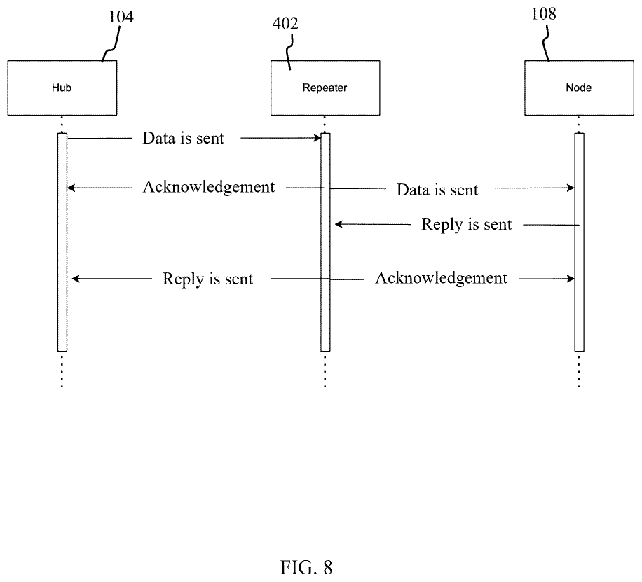

With reference now to FIGS. 7 and 8, the control and management system using direct sequence spread spectrum radio 100 may also comprise a repeater 702 configured to increase the available range. The repeater 702 may be located between the hub 104 and the nodes 108 such that the repeater 702 receives a message or data packet originating from the central access control system 102 that is broadcast by the hub 104, and then transmits the data packet to the nodes 108. Similarly, any response from the nodes 108 may be received by the repeater 402 and subsequently forwarded back to the central access control system 102 via the hub 104.

Latency introduced by the use of the repeater 702 may be minimized by increasing the bandwidth, thus decreasing the time on air, between the hub 104 and the repeater 702 and also between the nodes 108 and the repeater 702. Latency may also be reduced by combining an acknowledgement of data transmission with the data packet itself. For example, when the repeater 702 sends a data packet to a node 108, the hub 104 may be configured to use the same data transmission as an acknowledgement back to the central access control system 102 that the data packet from the 104 hub to the repeater 702 was sent. Similarly, when the repeater 702 sends the data packet to the hub 104, the node 108 may use the same data transmission as an acknowledgement that the data packet from the node 108 to the repeater 702 was sent.

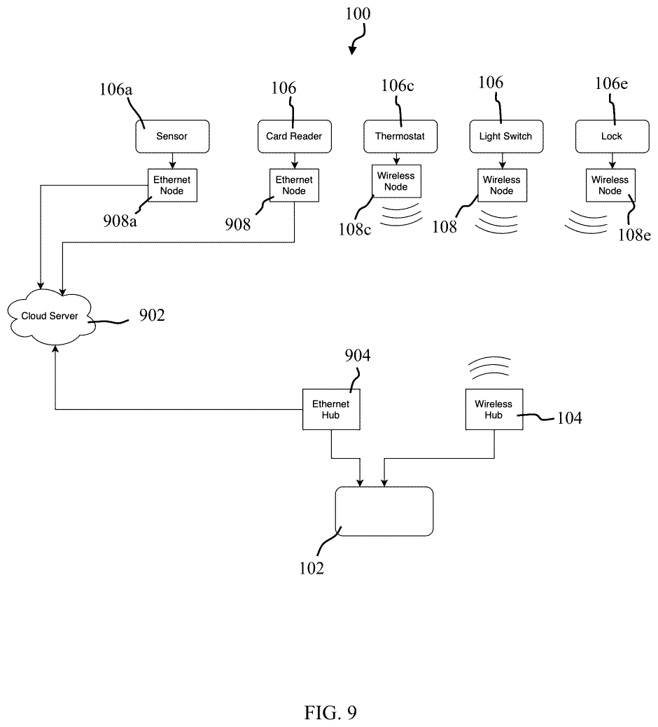

The control and management system using direct sequence spread spectrum radio 100 may also be configured to communicate directly over the internet. For example, referring now to FIG. 9, the central access control system 102 may be coupled to an ethernet hub 904 configured to communicate with one or more ethernet nodes 908a, 908b over a cloud server 902.

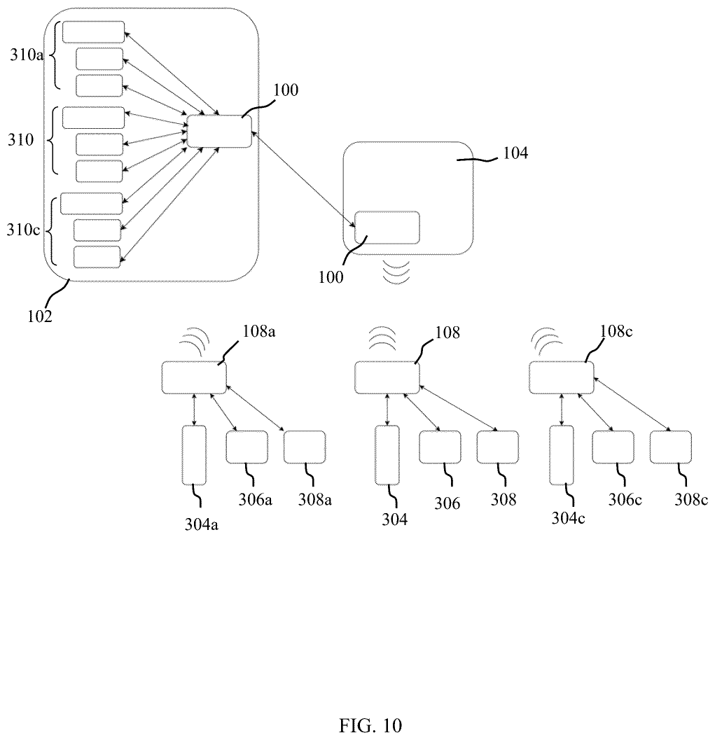

The control and management system using direct sequence spread spectrum radio 100 may also be configured to use an Open Supervised Device Protocol (OSDP) as an access control protocol to utilize bidirectional communication between the nodes 108 and the central access control system 102. For example, in one embodiment, and referring now to FIG. 10, incorporating an OSDP interface 1002 into the central access control system 102 and the hub 1004 may allow for communication of credential, relay, and sensor data, and also allows for commands to actuate a relay at a node 108 or at one of the peripherally connected remote devices 304a-c, 306a-c, 308a-c. The use of this protocol may also have an added benefit of reducing the number of wires required between the central access control system 102 and the hub 1004 and eliminate the need to include an adapter board 302 since multiple devices can share the a bus.

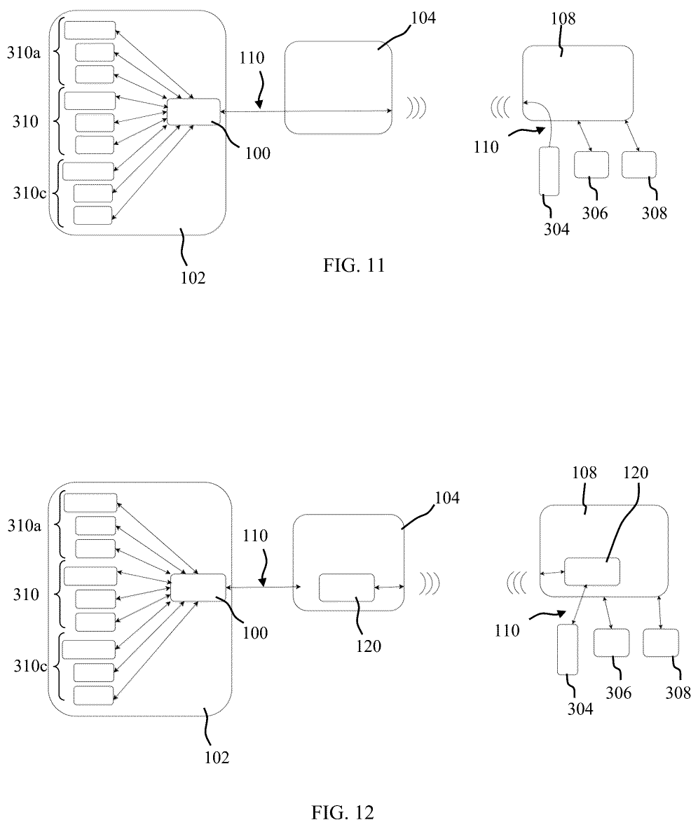

Since OSDP uses a supervision mechanism to periodically monitor the plurality of peripherally connected remote devices 304a-c, 306a-c, 308a-c, there are various ways in which the system 100 can communicate this data wirelessly to keep compliance with OSDP. Referring now to FIG. 11, a first method, the hub 104 and node 108 pass the OSDP data 1102, 1104 along in real-time as it is sent or received. This method may provide reduced or lowered latency, but if the spread spectrum radio settings result in a long time on air, the periodic monitoring from the master device, and the reply on each monitor ping from the slave device may not satisfy the OSDP timing requirements.

A second method may be to place the hub 104 in the role of a slave device 1202 (pretending to be a reader) and have the nodes 108 act as an OSDP master device 1204 (pretending to be an access control system). The hub 104 will ping the card reader 304 according to the OSDP to verify it is connected, and if the hub 104 receives data from the card reader 304 it will translate that data from the OSDP to a proprietary format that can be sent over a desired radio frequency. When the slave device 1202 receives that data wirelessly, it will re-format the data into the OSDP and send it to the central access control system 102. In this way, the time on air of data being sent over the proprietary spread spectrum radio is not a limiting factor for OSDP functionality.

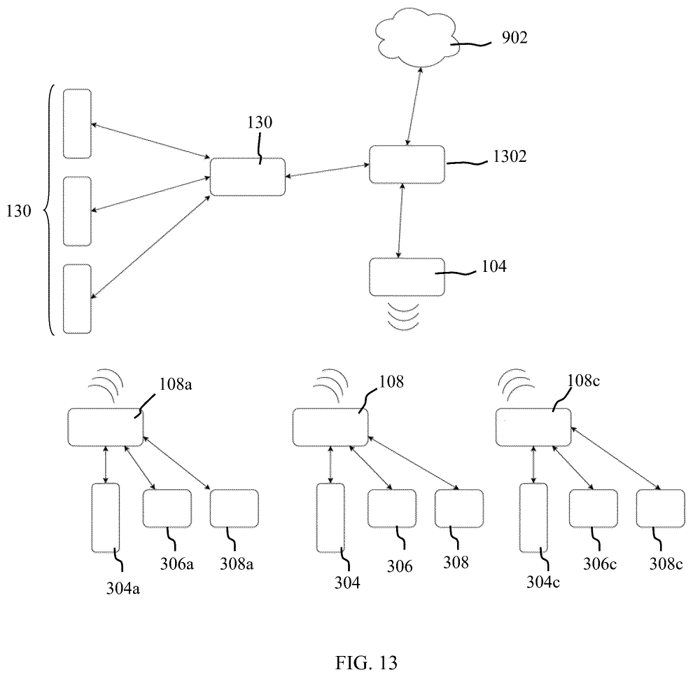

In another embodiment, the disclosed technology may also be configured to create an access control system that has the same or better response time than a wired system. In one representation of such a system and referring now FIG. 13, a gateway 1302 located on a premise may be configured to host a database of user credentials, schedules, and rules of which users are allowed to access doors within the premises. The gateway 1302 may be configured to synchronize the user database with the cloud over an internet connection. One or more wireless door controllers 308a-c that are installed near or otherwise within a proximity of one or more card readers 304a-c may also be configured to host a copy of the user database. When a change is made in a user facing web or mobile app, the gateway 1302 sends an update with new data to the nodes 108a-c to update the local copy of the user database. When a user uses a credential at a given card reader 304a-c connected to a node 108a-c, the respective node 108a-c may check its copy of the user database to determine if that user should be let in. Therefore, the logic to control access at a door resides as close to the door as possible and as a result may reduce response time and improve reliability. For example, if any node 108a-c should lose wireless communication, it can still function with its existing database. In this way, the central access control system 102 or hub 104 may be used to synchronize the user database across one or more of the nodes 108a-c. It is further envisioned that wired devices can also be directly connected to the gateway 1302, allowing for a hybrid of a wireless and wired access control system. This may allow for the expansion of existing wired systems to incorporate benefits or functionality of a wireless system at reduced installation cost.

As described herein, embodiments of each disclosed system have been described as being integrated within a single system and variously with each other; however, the technology should not be viewed as being limited in this respect. In some embodiments, each system may comprise a stand-alone system such that they may each be employed separately or in various combinations with one another or as integrated with other types of smart access systems.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. A control and management system for managing communication between a central controller and multiple remote nodes, comprising:
a central access control system configured to generate a data packet;
a hub communicatively linked to the central access control system, wherein the hub is configured to:
receive the data packet from the central access control system;
frequency hop across at least 50 different channels across a portion of a spread spectrum radio frequency corresponding to the 900 MHz band;
select a channel from the at least 50 channels;
transmit the data packet in the 900 MHz band on the selected channel in response to a command from the central access control system; and
transmit a preamble on the selected channel prior to the transmitting data packet; and
at least two wireless nodes configured to communicate across the same at least 50 different channels as the hub, wherein each wireless node is connected to a remote device and is configured to:
continuously scan each channel for the preamble;
upon detection of the preamble on the selected channel, stop scanning to receive the data packet on the selected channel;
determine if the data packet was intended for the connected remote device;
transmit a reply back to the hub on the selected channel if the data packet was intended for the connected device, wherein the node is configured to transmit the preamble back to the hub prior to the reply; and
return to scanning each channel after the reply is sent.

2. A control system according to claim 1, wherein the preamble comprises a predetermined sequence of data having a set length and broadcast airtime.

3. A control system according to claim 1, wherein the hub is further configured to:
detect the preamble from the wireless node sending the reply;
transmit the reply to the central access control system; and
transmit a confirmation of success back to the wireless node.

4. A control system according to claim 1, wherein the data packet comprises:
a device ID corresponding to the remote device intended to receive the data packet; and
a set of instructions for remote device.

5. A control system according to claim 4, wherein each wireless node is further configured to:
identify the device ID within the data packet;
compare the device ID within the data packet to the device ID of the connected remote device; and
disregard the data packet if the device ID within the data packet does not match the device ID of the connected remote device.

6. A control system according to claim 1, further comprising a repeater configured to receive the preamble and data packet from the hub and retransmit them to the least two wireless nodes on the selected channel.

7. A control system according to claim 6, wherein the repeater is further configured to:
transmit an acknowledgement back to the hub after retransmitting the data packet;
receive a reply from the intended wireless node;
transmit the reply to the hub; and
transmit an acknowledgement back to the intended wire node after transmitting the data packet to the hub.

8. A control system according to claim 6, wherein the repeater and the hub are configured with an adjustable transmission rate configured to equalize latency across each remote connected device.

9. A control system according to claim 1, further comprising at least one adapter device, wherein the adapter device:
is wired to the central access control system; and
configured to wirelessly transmit data between the hub and the central access control system using a secondary wireless protocol.

10. A control system according to claim 9, wherein the secondary wireless protocol comprises at least one of: Bluetooth low energy, Wi-Fi, and a 900 Mhz narrow band protocol.

11. A control system according to claim 1, wherein the central access control system further comprises an Open Supervised Device Protocol (OSDP) interface configured to communicate with the hub.

12. A control system according to claim 11, wherein at least one of the hub and at least two wireless nodes comprises a second OSDP interface configured to communicate with the OSDP interface in the central access control system.

13. A control system according to claim 1, wherein the hub further comprises at least two receivers configured to allow the hub to exchange data simultaneously with at least two different wireless nodes.

14. A control system according to claim 1, wherein the central access control system is further configured to exchange data through an ethernet hub.

15. A control and management system for managing communication between a central controller and multiple remote nodes, comprising:
a central access control system configured to generate a data packet;
a hub communicatively linked to the central access control system, wherein the hub is configured to:
receive the data packet from the central access control system;
select a channel from within a predetermined radio frequency (RF) range;
transmit a preamble on the selected channel prior; and
transmit a data packet on the selected channel in response to a command from the central access control system within a predetermined timeframe following the transmission of the preamble; and
at least two wireless nodes configured to communicate across the predetermined RF range, wherein each wireless node is communicatively linked to a remote device and is configured to:
continuously scan a predetermined number of channels within the RF range for the preamble;
upon detection of the preamble on the selected channel, stop channel scanning to receive the data packet on the selected channel;
transmit a reply back to the hub on the selected channel upon receipt of the data packet, wherein the node is configured to transmit the preamble back to the hub prior to transmitting the reply; and
return to scanning each channel after the reply is sent.

16. A control system according to claim 15, wherein the hub is configured to continuously scan a predetermined number of channels within the RF range for the preamble transmitted by the at least two wireless nodes.

17. A control system according to claim 15, wherein the preamble comprises a predetermined sequence of data having a set length and broadcast airtime.

18. A control system according to claim 17, wherein each wireless node is able to scan all of the predetermined number of channels before the entire preamble is transmitted.

19. A control system according to claim 15, wherein the data packet comprises:
a device ID corresponding to the remote device intended to receive the data packet; and
a set of instructions for remote device.

20. A control system according to claim 19, wherein each wireless node is further configured to:
identify the device ID within the data packet;
compare the device ID within the data packet to the device ID of the connected remote device; and
disregard the data packet if the device ID within the data packet does not match the device ID of the connected remote device.
